(19) United States
(12) Patent Application Publication
(10) Pub. No.: US 2015/0097767 A1
(43) Pub. Date: Apr. 9, 2015

(54) SYSTEM FOR VIRTUAL EXPERIENCE BOOK AND METHOD THEREOF

(71) Applicant: Electronics and Telecommunications Research Institute, Daejeon (KR)

(72) Inventors: Su Ran PARK, Daejeon (KR); Hyun Bin KIM, Daejeon (KR); Seong Won RYU, Daejeon (KR); Ki Suk LEE, Daejeon (KR)

(73) Assignee: Electronics and Telecommunications Research Institute, Daejeon (KR)

(21) Appl. No.: 14/247,846

(22) Filed: Apr. 8, 2014

(30) Foreign Application Priority Data
Oct. 7, 2013 (KR) 10-2013-0119211

(51) Int. Cl. G06T 19/00; G06F 3/01

(52) U.S. Cl. CPC G06T 19/006; G06F 3/017
USPC 345/156

(57) ABSTRACT

Provided are a virtual experience book system and a method for operating the same, the system including a virtual experience book producing device configured to generate 3D virtual image content in consideration of a plurality of objects extracted from text information of a story, and a virtual experience book control device configured to detect a body motion of a user while displaying the 3D virtual image content, and control a represented image of the 3D virtual image content so that a viewpoint is switched or arrangement locations of 3D models are changed according to the detected body motion.

### CROSS-REFERENCE TO RELATED APPLICATIONS

This application claims priority under 35 U.S.C. §119 to Korean Patent Application No. 10-2013-0119211, filed on Oct. 7, 2013, the disclosure of which is incorporated herein by reference in its entirety.

### TECHNICAL FIELD

The present invention relates to a virtual experience book system, and more particularly, to a technology for producing 3D virtual image content from a story in a book by using 3D computer graphics and for providing the 3D virtual image content to a user so that the user virtually experiences the story.

### BACKGROUND

Electronic books represent digital books produced by recording texts or images in electronic media so as to be used like books. Such electronic books are much cheaper than paper books, and only needed parts of the electronic books may be purchased. Furthermore, electronic books allow a user to view video data or listen to background music while reading texts. Moreover, electronics books may be stored in mobile terminals such as PDAs and cell phones so that the user may read the books regardless of time and place. In addition, electronic books may allow a publisher to save the cost of printing and bookbinding and the distribution cost and update the content of the books easily, and may lessen the inventory burden of the publisher.

Recently, Digilog books have received great attention as electronic books. Digilog books are new-concept next-generation electronic books in which advantages of analog books and advantages of digital content are combined so that a user may feel both analog sensitivity and digital five senses. That is, digital content is added to conventional book content so that a reader may three-dimensionally enjoy various experiences stimulating senses of sight, hearing and touch.

However, such Digilog books are merely provided to a user as a three-dimensional image obtained by photographing a picture printed on a book by using a camera. Therefore, Digilog books cannot allow the user to experience a story space of a book or allow the user (reader) to virtually experience a book story as a main character of the story.

### SUMMARY

Accordingly, the present invention provides a technical solution for enabling a reader to virtually experience a book story by generating and proving 3D virtual image content of the book story.

In one general aspect, a virtual experience book system includes a virtual experience book producing device configured to generate 3D virtual image content in consideration of a plurality of objects extracted from text information of a story, and a virtual experience book control device configured to detect a body motion of a user while displaying the 3D virtual image, and control a represented image of the 3D virtual image content so that a viewpoint is switched or arrangement locations of 3D models are changed according to the detected body motion.

The virtual experience book producing device may include an input unit configured to receive the text information of the story, an analysis processing unit configured to extract the plurality of objects from the text information using a language analysis algorithm, and an image generating unit configured to generate the 3D virtual image content using 3D computer graphics in consideration of the plurality of extracted objects. The virtual experience book control device may include a display unit configured to display the represented image of the 3D virtual image content to provide the represented image of the 3D virtual image to the user, a motion detection unit configured to detect the body motion of the user, and a control unit configured to control the represented image of the 3D virtual image content according to a selection motion when the selection motion of the user is detected through the motion detection unit while the represented image of the 3D virtual image content is displayed through the display unit.

The image generating unit may obtain the 3D models respectively corresponding to the plurality of objects extracted from an extraction unit from a database so as to generate the 3D virtual image content. Furthermore, the image generating unit may arrange the obtained 3D models according to a preset arrangement rule so as to generate the 3D virtual image content. When the 3D model corresponding to the object does not exist in the database, the image generating unit may obtain a 3D model that is most similar to the object from the database.

The analysis processing unit may extract at least one of a background, a character, a noun, and a verb from the text information as the object. The image generating unit may generate the 3D virtual image content based on at least one of a first-person point of view and a third-person point of view of the story.

The motion detection unit may detect at least one of body bending, a rotation direction, a step, and a hand motion of the user. The display unit may be a head mounted display mounted on a body of the user.

The control unit may switch a viewpoint of the 3D virtual image content so that the viewpoint becomes the first-person point of view or the third-person point of view according to manipulation or motion of the user. When a selection motion of the user is detected through the motion detection unit while the represented image of the 3D virtual image content is displayed through the display unit, the control unit may change arrangement locations of the 3D models included in the 3D virtual image content according to the detected selection motion.

In another general aspect, a method for producing a virtual experience book by a virtual experience book system include receiving text information of a story, extracting a plurality of objects from the text information using a language analysis algorithm, and generating 3D virtual image content using 3D computer graphics in consideration of the plurality of extracted objects.

The extracting may include extracting at least one of a background, a character, a noun, and a verb from the text information as the object. The generating may include obtaining 3D models respectively corresponding to the plurality of extracted objects from a database, and arranging the obtained 3D models according to a preset arrangement rule so as to generate the 3D virtual image content.

The obtaining may include obtaining, when the 3D model corresponding to the object does not exist in the database, a 3D model that is most similar to the object from the database. The generating may include generating the 3D virtual image content based on at least one of a first-person point of view and a third-person point of view of the story.

In another general aspect, a method for controlling a virtual experience book by a virtual experience book system includes displaying a represented image of 3D virtual image content to provide the represented image of the 3D virtual image to a user, detecting a body motion of the user, and controlling the represented image of the 3D virtual image content so that a viewpoint is switched or arrangement locations of the 3D models are changed according to a selection motion when the selection motion of the user is detected while the represented image of the 3D virtual image content is displayed through the display unit.

The detecting may include detecting at least one of body bending, a rotation direction, a step, and a hand motion of the user.

The controlling may include switching the viewpoint of the 3D virtual image content so that the viewpoint becomes a first-person point of view or a third-person point of view according to manipulation of the user. The controlling may include checking whether the selection motion of the user is detected while the represented image of the 3D virtual image content is displayed, and controlling, when the selection motion of the user is detected, the 3D models so that arrangement locations of the 3D models included in the 3D virtual image content are changed according to the detected selection motion.

### BRIEF DESCRIPTION OF THE DRAWINGS

FIG. 1 is a block diagram illustrating a virtual experience book producing device according to an embodiment of the present invention.

FIG. 2 is a block diagram illustrating a virtual experience book control device according to an embodiment of the present invention.

FIG. 3 is an exemplary diagram illustrating a virtual experience book control device according to the present invention.

FIGS. 4A and 4B are flowcharts illustrating provision of 3D virtual image content according to the present invention.

FIG. 5 is a flowchart illustrating a method for operating a virtual experience book producing device according to an embodiment of the present invention.

FIG. 6 is a flowchart illustrating a method for operating a virtual experience book control device according to an embodiment of the present invention.

FIG. 7 is block diagram illustrating a computer system for implementing a virtual experience book system.

### DETAILED DESCRIPTION OF EMBODIMENTS

Further aspects of the present invention described above will be clarified through the following embodiments described with reference to the accompanying drawings. Hereinafter, embodiments of the present invention will be described in detail in order for those skilled in the art to easily understand and reproduce the present invention through the embodiments.

A virtual experience book is produced by forming a virtual space (3D virtual image content) from a story space in which a story of a book is developed by using 3D computer graphics. For example, the virtual experience book may allow a reader to virtually experience a story of a book as a main character of the story or observe a character experience the story from a third-person point of view.

A virtual experience book system includes a virtual experience book producing device 100 and a virtual experience book control device 200.

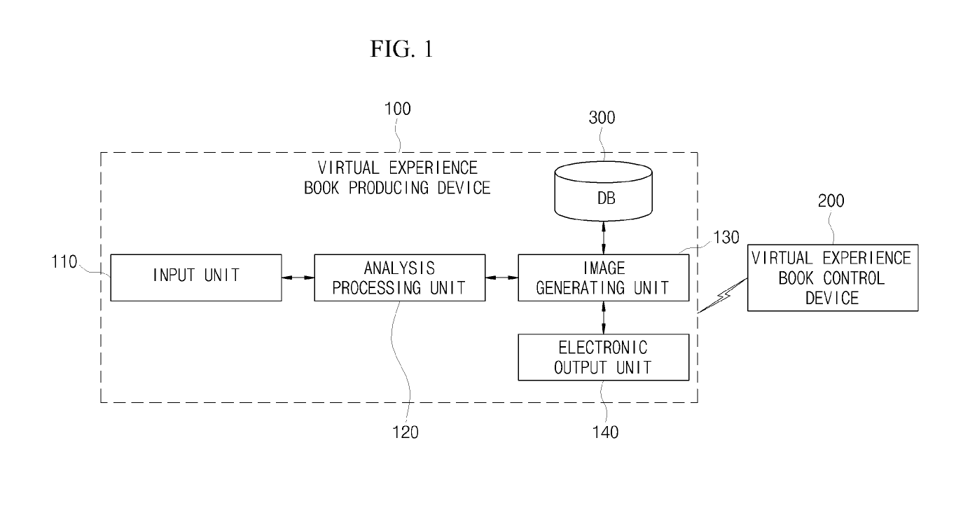

FIG. 1 is a block diagram illustrating a virtual experience book producing device according to an embodiment of the present invention. The virtual experience book producing device 100 is configured to generate 3D virtual image content of a virtual experience book, and includes an input unit 110, an analysis processing unit 120, and an image generating unit 130.

The input unit 110 receives text information of a book story for which a virtual experience book is to be produced. For example, the input unit 110 may receive text-form information from a virtual experience book producing worker. For another example, the input unit 110 may read characters printed on a paper book by using an Optical Character Reader (OCR) so as to receive text information. Here, the input unit 110 may receive entire text information of a book story for which a virtual experience book is to be produced. Alternatively, the input unit 110 may receive text information for each chapter of a book story for which a virtual experience book is to be produced.

The analysis processing unit 120 extracts a plurality of objects from the text information input through the input unit 110. In detail, the analysis processing unit 120 may analyze word spacing, morphemes, and natural language in a plurality of sentences included in the text information input through the input unit 110 by using a language analysis algorithm. For example, the analysis processing unit 120 extracts at least one of a background, a character, a noun, and a verb from analyzed text information. Here, the analysis processing unit 120 may also extract a modifier that describes an object.

For example, in the case where the text information of ‘there is a green birdhouse with a pointed roof in front of green trees, and a red bird sits on the roof of the birdhouse’ is received through the input unit 110, the analysis processing unit 120 may extract objects such as ‘green trees’, ‘a green birdhouse with a pointed roof’, ‘there is’, ‘a birdhouse with a roof’, ‘on’, ‘a red bird’, and ‘sits’. Such multiple objects may be differently extracted according to the language analysis algorithm and a setting thereof. Preferably, the analysis processing unit 120 may generate an object list of a plurality of objects extracted from a plurality of sentences.

The image generating unit 130 generates 3D virtual image content by using 3D computer graphics in consideration of the plurality of objects extracted by the analysis processing unit 120. Preferably, the image generating unit 130 obtains 3D models from a database 300 by using the object list obtained from the analysis processing unit 120. Here, a 3D model for each object is preset and stored in the database 300. Alternatively, a plurality of 3D models may be stored for each model in the database 300 according to similarities with the objects.

The image generating unit 130 obtains 3D models respectively corresponding to the plurality of objects from the database 300 by using the object list received from the analysis processing unit 120. In the case where a 3D model corresponding to an object is not stored in the database 300, the image generating unit 130 may obtain a 3D model that is most similar (having a highest similarity) to the object.

For example, with respect to the object ‘green trees’ extracted by the analysis processing unit 120, the image generating unit 130 obtains a 3D model representing green trees from the database 300. In the case where there are a plurality of 3D models corresponding to the ‘green trees’ in the database 300, the image generating unit 130 may obtain a 3D model which is used highly frequently among the 3D models, or may obtain a 3D model selected by a virtual experience book producer.

For another example, in the case where a 3D model corresponding to the ‘birdhouse with a pointed roof’ exists but the color thereof is not green, the image generating unit 130 may change the color into green so as to obtain the 3D model. Here, changed 3D model information may be updated and stored in the database 300.

For another example, in the case where there are a plurality of 3D models corresponding to the ‘red bird’, a 3D model having a highest ratio of red color and having a highest similarity to the ‘red bird’ may be obtained from the database 300.

As described above, the image generating unit 130 may generate 3D virtual image content by using 3D models obtained from the database 300. Here, the image generating unit 130 may generate the 3D virtual image content on the basis of 3D game programming. The image generating unit 130 arranges the obtained 3D models according to a preset arrangement rule by using 3D computer graphics to thereby generate the 3D virtual image content. Here, the image generating unit 130 may firstly generate an initial 3D virtual image that forms a basic frame of the 3D virtual image content. Here, the arrangement rule may include a rule for distances among 3D models and a rule for rotation and modification thereof.

For example, in the case where the text information of ‘there is a green birdhouse with a pointed roof in front of green trees, and a red bird sits on the birdhouse’ is received through the input unit 110, the image generating unit 130 may generate a screen of the 3D virtual image content so that a red bird sits on a green birdhouse with a pointed roof and the green birdhouse with the pointed roof is positioned in front of green trees. Thereafter, the image generating unit 130 may arrange 3D models corresponding to a plurality of objects obtained from a next connected sentence and generate a screen to thereby generate a 3D virtual image that ultimately has continuity.

Furthermore, each 3D model may be differently arranged and applied according to a viewpoint. Here, the viewpoint may be at least one of a first-person point of view and a third-person point of view. For example, in the case of the first-person point of view, the image generating unit 130 may generate the 3D virtual image content based on the first-person point of view so that a reader virtually experiences a story of a book as a main character of the book. For example, in the case where a ‘red bird’ is a main character, the image generating unit 130 may generate the 3D virtual image content so that a user (a reader, or a person experiencing a virtual book) views other 3D models as if the user were the red bird and sat on a green birdhouse with a pointed roof. Here, the image generating unit 130 may generate the 3D virtual image content in consideration of the case where a gaze of a character rotates (360° rotation). In addition, the image generating unit 130 may generate the 3D virtual image content in consideration of the case where the user views as a character of the book story other than the main character.

For another example, in the case of the third-person point of view, the image generating unit 130 may generate the 3D virtual image content based on the third-person point of view so that a reader observes that a character experiences a book story. Through this process, the image generating unit 130 may generate screens of the 3D virtual image content according to a story flow of a book and connect the screens so as to generate the 3D virtual image.

Furthermore, the image generating unit 130 may provide a user-oriented editing function so that the initial 3D virtual image may be edited according to manipulation of a virtual experience book producer. For example, the image generating unit 130 may change rotation, modification, and sizes of 3D models of the initial 3D virtual image content according to manipulation of the producer, and may also change materials of the 3D models. According to circumstances, the image generating unit 130 may include voice information in the 3D virtual image content. For example, in the case where an object (ex, ‘(a bird) twitters’) that requires a sound is extracted by the analysis processing unit 120 among verbs that represent movement of a character, the image generating unit 130 may obtain a sound file corresponding to the extracted object from the database 300 or a separate memory and include the sound file in the 3D virtual image content.

Furthermore, the image generating unit 130 may add a function of generating and processing an event of a user according to manipulation of the virtual experience book producer so as to generate the 3D virtual image content. In detail, the image generating unit 130 may include an event (ex, a mission, a quest, or a quiz) that may be performed by a user (reader) while the user virtually experience a virtual space through the virtual experience book according to input by the virtual experience book producer to generate the 3D virtual image content. For example, by the virtual experience book producer, the image generating unit 130 may include, in the 3D virtual image content, an event that may be performed by a reader when a reader selects a specific character or a specific 3D model. For another example, a notification of existence of an event may be overlaid on an image so as to be displayed on a screen when a specific screen is played while the 3D virtual image content of the virtual experience book is played.

The virtual experience book producing device 100 may further include an electronic output unit 140. The electronic output unit 140 may determine a specific value of the 3D virtual image content, render the 3D virtual image content, and electronically output the 3D virtual image content in order to optimize the 3D virtual image content in a media device where the 3D virtual image content generated in the image generation unit 130 is played (executed). For example, the 3D virtual image content may be electronically output in the form of a unique application so as to be performed through a device (virtual experience book control device 200) capable of performing the virtual experience book. Furthermore, the image generating unit 140 may determine a graphic pixel value and size of the 3D virtual image content according to specifications of the virtual experience book control device 200.

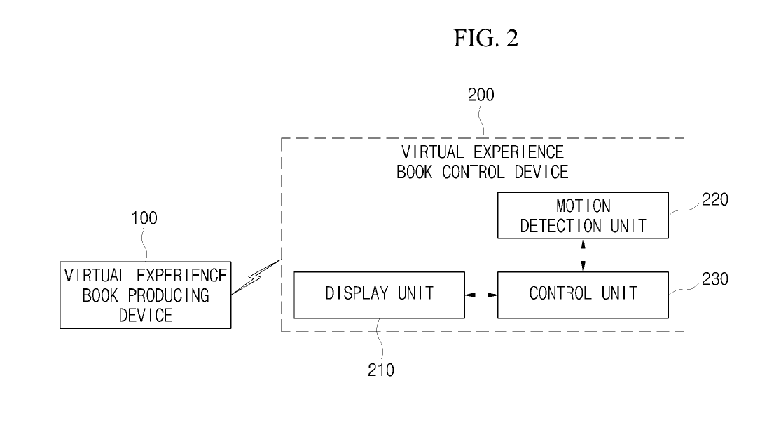

FIG. 2 is a block diagram illustrating the virtual experience book control device according to an embodiment of the present invention. The virtual experience book control device 200 is configured to play the 3D virtual image content of the virtual experience book generated by the virtual experience book producing device 100, provide the 3D virtual image content to a user (reader), and control a represented image of the 3D virtual image content by detecting motion of the user. As shown, the virtual experience book control device 200 includes a display unit 210, a motion detection unit 220, and a control unit 230.

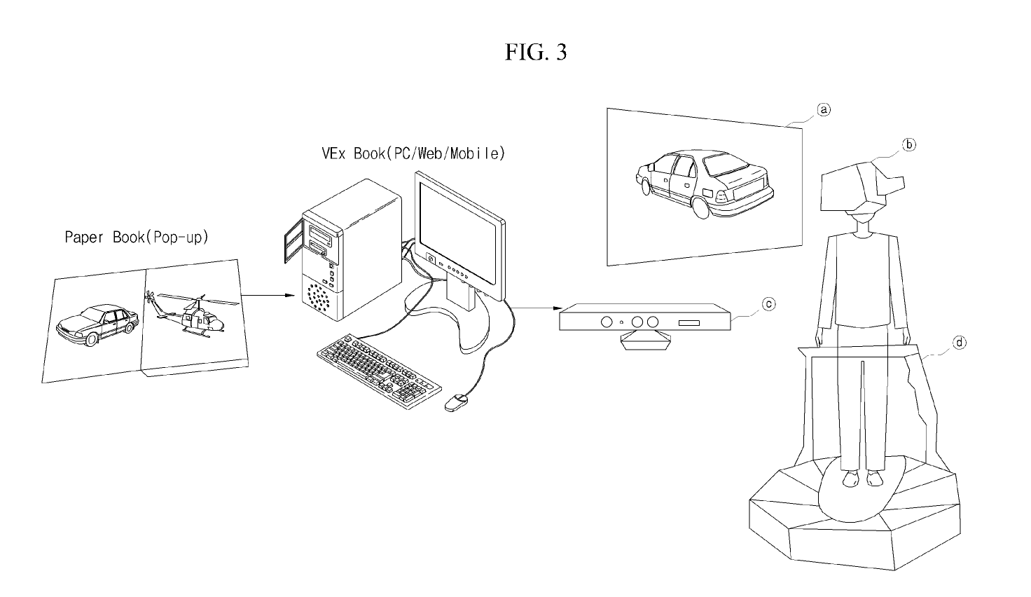

The display unit 210 displays the represented image of the 3D virtual image content of the virtual experience book on a screen to provide the image to the user (reader). For example, as illustrated in a portion \textcircled{a} of FIG. 3, the display unit 210 may be a Liquid Crystal Display (LCD) capable of playing a 3D image. For another example, the display unit 210 may be a wearable glass or goggle type display device. Preferably, as illustrated in a portion \textcircled{b} of FIG. 3, the display unit 210 may be a Head Mounted Display (HMD) to be mounted on a body (head) of a user. The represented image of the 3D virtual image content is controlled according to motion of the user detected by the motion detection unit 220 so as to be output to a screen through the display unit 210.

The motion detection unit 220 detects motion of the user (reader). Here, the motion detection unit 220 may detect at least one of body bending, a body rotation direction, a step, and a hand motion of the user. For example, the motion detection unit 220 may be equipped with a camera module to detect a body motion of the user by capturing the motion of the user, and may be Kinect of Microsoft Corporation, as illustrated in a portion \textcircled{c} of FIG. 3. For another example, the motion detection unit 220 may include a support and a foothold for holding the body of the user to detect the body motion of the user, and may be Omni of Virtuix company, as illustrated in a portion \textcircled{d} of FIG. 3. Preferably, the motion detection unit 220 may include both the Kinect and the Virtuix Omni to detect body motions of the user, such as a hand motion and body bending, through the Kinect and detect body motions of the user, such as a body rotation direction and a step, through the Virtuix Omni.

The control unit 230 which is configured to perform an overall process of the virtual experience book control device 200 performs a control operation so that the 3D virtual image content generated by the virtual experience producing device 100 is played and the represented image of the 3D virtual image content is displayed on a screen through the display unit 210. At the same time, when the body motion of the user is detected through the motion detection unit 220, the control unit 210 accordingly controls the represented image of the 3D virtual image content displayed on a screen through the display unit 210.

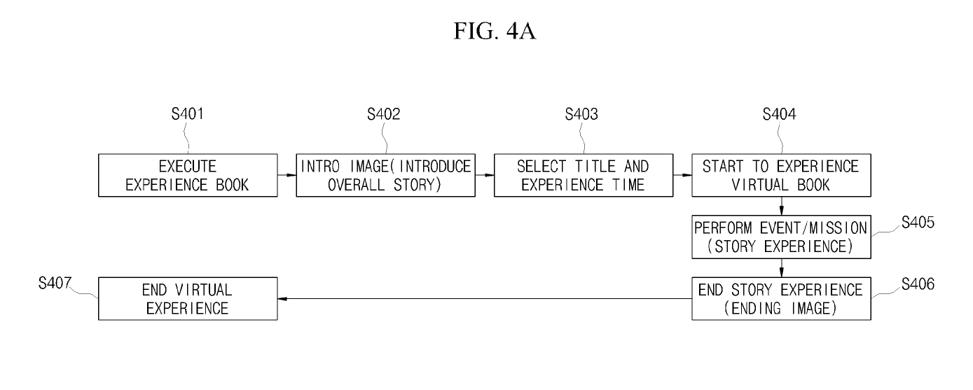

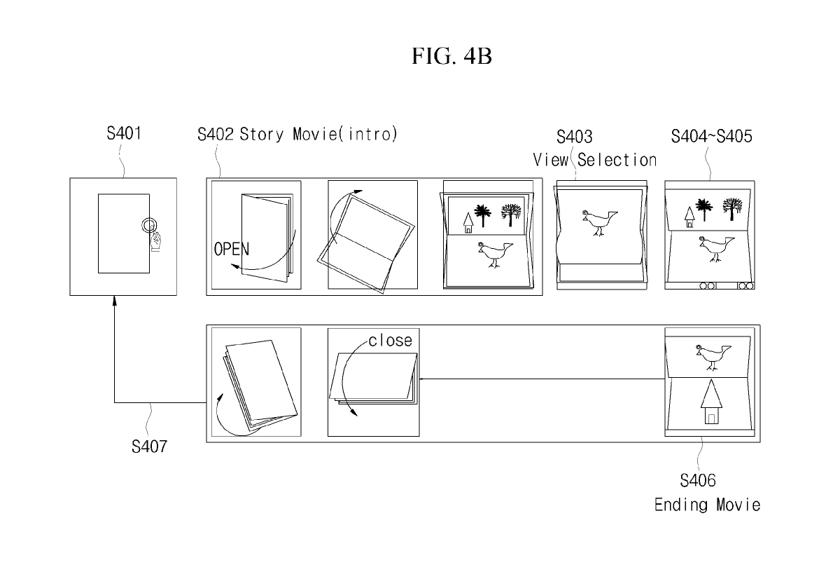

Hereinafter, operation of the control unit 230 will be described in detail with reference to FIGS. 4A and 4B. Firstly, when the virtual experience book is executed by manipulation of the user (reader) in operation 5401, the control unit 230 displays an intro image of the 3D virtual image content on a screen through the display unit 210 so as to play the intro image in operation 5402. Here, the intro image may be an image for introducing a summary of a book story. For example, the control unit 230 continuously detects a hand motion of the user and a position thereof through the motion detection unit 220 to overlay the detected motion and position on the represented image (screen) of the 3D virtual image content displayed through the display unit 210. The control unit 230 checks whether the motion detection unit 220 detects that a hand of the user clicks on an execution location of a screen (ex, a right edge of a book image displayed on a screen). If the clicking motion of the hand is detected, the control unit 230 starts a virtual experience book control process, and displays an intro image among a plurality of images included in the 3D virtual image content through the display unit 210.

When playback of the intro image is completed, the control unit 230 detects a selection motion of the user through the motion detection unit 220 to determine whether to play the 3D virtual image content based on a first-person point of view or a third-person point of view in operation S403. Here, selection manipulation of the user may be performed according to a hand position and a hand motion of the user detected through the motion detection unit 220.

For example, in the case where the selection of the user detected through the motion detection unit 220 is the first-person point of view, the control unit 230 may perform a control operation so that the represented image of the 3D virtual image content is displayed on a screen through the display unit 210 from the first-person point of view, as illustrated in a portion \textcircled{a} of FIG. 3. Furthermore, the control unit 230 may detect a body motion of the user through the motion detection unit 220 to control the represented image of the 3D virtual image content that is currently played.

For example, when a running step of the user is detected through the motion detection unit 220, the control unit 230 increases a scene switching rate of the represented image displayed on a screen through the display unit 210 according to a running speed of the user so that the user feels as if the user ran in a virtual space of the 3D virtual image content. When a body rotation of the user is detected through the motion detection unit 220, the control unit 230 may rotate a scene of the represented image displayed through the display unit 210 according to a rotation direction of the user. This operation may bring about an effect of switching a direction of a character (main character) or a gaze direction in the virtual space of the 3D virtual image content. The screen switching of the 3D virtual image content according to a body motion of the user may be performed in the same manner as that of 3D game programming.

For another example, in the case where the selection of the user detected through the motion detection unit 220 is the third-person point of view, the control unit 230 performs a control operation so that the 3D virtual image content is played and displayed on a screen through the display unit 210 from the third-person point of view. When a body rotation of the user is detected through the motion detection unit 220, the control unit 230 may rotate a scene of the represented image displayed through the display unit 210 according to a rotation direction of the user. This operation may bring about an effect of switching a gaze direction of an observer viewing the virtual space of the 3D virtual image content regardless of a gaze of a character.

Furthermore, the control unit 230 may detect the selection manipulation of the user through the motion detection unit 220 even while the 3D virtual image content is played, so as to changed a viewpoint of the represented image of the 3D virtual image content to another viewpoint (ex, a first-person point of view→a third-person point of view or a third-person point of view→a first-person point of view).

In addition, in the case where a screen (scene) in which an event is presorted by the virtual experience book producer is displayed through the display unit 210 while the 3D virtual image content is played, the control unit 230 may notify the user that an event exists in a currently played image. Here, the event may be a mission, a quest, or a quiz, and may require selection manipulation of the user. In the case where event information is stored in a scene of the currently represented image, the control unit 230 may pop up or overlay screen information for requiring user selection or may display a flickering 3D object related to the event so as to notify the existence of the event to the user (experiencer). For another example, the control unit 230 may output a sound (voice) so as to notify the existence of the event.

When the event is selected and performed by selection manipulation of the user, the control unit 230 may provide guide information for performing the event to the user in operation S404. As illustrated in FIGS. 4A and 4B, the control unit 230 may display an arrow with a text such as ‘touch’ and ‘move’ to guide the user to make an input. Thereafter, when a right motion of the user for completing performance of the event is detected through the motion detection unit 220, the control unit 230 may display a next scene (screen) of the 3D virtual image content on a screen through the display unit 210 in operation S405.

For example, when a motion of the user is detected through the motion detection unit 220, and a 3D model is selected and is dragged to be moved on a set location, the control unit 230 may notify the user that the event performance is completed, and may display an image of a next screen or the 3D virtual image content through the display unit 210. Alternatively, when a motion of the user is detected through the motion detection unit 220, and an event pass is selected, the control unit 230 may display an image of a next screen or the 3D virtual image content through the display unit 210 regardless of whether the event is completed.

When all images of the 3D virtual image content have been displayed and provided to the user through the display unit 210, the control unit 230 may notify the user that the playback of the 3D virtual image content is completed in operation S406. For example, the control unit 230 may play and display an ending image included in the 3D virtual image content through the display unit 210 so as to notify the user that the playback of the 3D virtual image content is completed.

Thereafter, as illustrated in FIGS. 4A and 4B, the control unit 230 may display an image in which a book image of the virtual experience book is folded through the display unit 210 so as to terminate all processes of the virtual experience book control device 200 in operation S407.

As described above, according to an embodiment of the present invention, a 3D-game-based immersive virtual reality generation and experience device is provided beyond the concept of reading and viewing texts and pictures of analog books, so that a virtual experience book user (reader) may experience a book story through interaction such as walking or running in a virtual space of the book story, and may improve information understanding and learning ability through virtual experience performing various missions and events.

According to another embodiment of the present invention, the 3D virtual image is generated based on viewpoints of various characters in addition to a viewpoint of a writer, so that the user may enjoy a single book story from multiple viewpoints such as a first-person point of view and a third-person point of view.

Furthermore, the present invention may be used in the fields of information knowledge transfer, education, and entertainment according to the theme of a book story. If a traditional fairy tale or a history is provided in the form of a virtual experience book, intangible culture content may be generated into tangible content to be used as a tool for culture experience or education. Moreover, a physical exercise effect may also be obtained through control based on physical activity, and thus, the virtual book may also be used for physical strength improvement and exercise promotion.

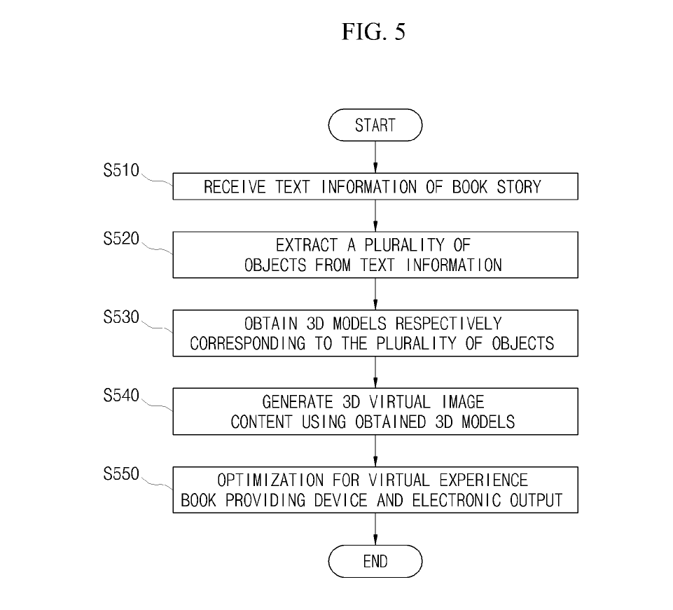

FIG. 5 is a flowchart illustrating a method for operating a virtual experience book producing device according to an embodiment of the present invention.

The virtual experience book producing device 100 receives text information of a book story for which a virtual experience book is to be produced in operation 5510.

For example, the virtual experience book producing device 100 may receive text-form information from a virtual experience book producing worker. For another example, the virtual experience book producing device 100 may read characters printed on a paper book by using an Optical Character Reader (OCR) so as to receive text information.

The virtual experience book producing device 100 extracts a plurality of objects from the text information received in operation 5510, in operation 5520.

In detail, the virtual experience book producing device 100 may analyze word spacing, morphemes, and natural language in a plurality of sentences included in the text information input through the input unit 110 by using a language analysis algorithm. For example, the virtual experience book producing device 100 extracts at least one of a background, a character, a noun, and a verb from analyzed text information. Here, the virtual experience book producing device 100 may also extract a modifier that describes an object.

The virtual experience book producing device 100 obtains a 3D model corresponding to the plurality of objects extracted in operation S520 from a database 300 in operation S530.

In detail, the virtual experience book producing device 100 obtains a 3D model corresponding to each of the plurality of objects from the database 300. Here, a 3D model for each object is preset and stored in the database 300. Alternatively, a plurality of 3D models may be stored for each model in the database 300 according to similarities with the objects. When a 3D model corresponding to an object is not stored in the database 300, the virtual experience book producing device 100 may obtain a 3D model that is most similar (having a highest degree of similarity) to the object.

The virtual experience book producing device 100 generates 3D virtual image content by using 3D models obtained in operation S530, in operation S540.

In detail, the virtual experience book producing device 100 may generate the 3D virtual image content on the basis of 3D game programming. The virtual experience book producing device 100 arranges the 3D models according to a preset arrangement rule by using 3D computer graphics to thereby generate the 3D virtual image content.

Here, the virtual experience book producing device 100 may differently arrange the 3D models according to a viewpoint to generate an image of the 3D virtual image content. For example, in the case of a first-person point of view, the virtual experience book producing device 100 may generate the 3D virtual image content based on the first-person point of view so that a reader (experiencer) virtually experiences a story of a book as a main character of the book. Here, the virtual experience book producing device 100 may generate the 3D virtual image content in consideration of the case where a gaze of a character rotates (360° rotation). For another example, in the case of a third-person point of view, the virtual experience book producing device 130 may generate the 3D virtual image content based on the third-person point of view so that the reader observes that a character experiences a book story.

Furthermore, the virtual experience book producing device 100 may add a function of generating and processing an event of a user according to manipulation of the virtual experience book producer so as to generate the 3D virtual image content. In detail, the virtual experience book producing device 100 may include an event (ex, a mission, a quest, or a quiz) that may be performed by the user (reader) while the user virtually experience a virtual space through the virtual experience book according to input by the virtual experience book producer to generate the 3D virtual image content.

In addition, the virtual experience book producing device 100 may determine a specific value of the 3D virtual image content, render the 3D virtual image content, and electronically output the 3D virtual image content in order to optimize the 3D virtual image content in a media device (virtual experience book control device 200) where the 3D virtual image content generated in operation S540 is played (executed).

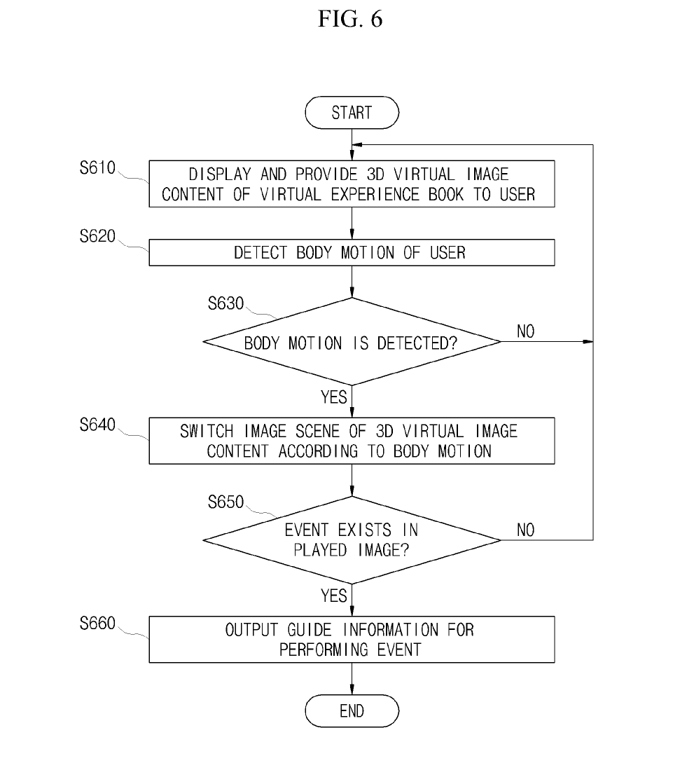

FIG. 6 is a flowchart illustrating a method for operating a virtual experience book control device according to an embodiment of the present invention.

The virtual experience book control device 200 displays a represented image of the 3D virtual image content of the virtual experience book on a screen to provide the image to the user in operation S610.

For example, as illustrated in a portion \textcircled{a} of FIG. 3, the virtual experience book control device 200 may display the represented image of the 3D virtual image content on a screen through a liquid crystal display (LCD) capable of playing a 3D image. For another example, as illustrated in a portion \textcircled{b} of FIG. 3, the virtual experience book control device 200 may display the 3D virtual image content on a screen through a Head Mounted Display (HMD) to be mounted on a body (head) of the user.

The virtual experience control device 200 detects motion of the user (reader) in operation S620 while performing operation S610.

Here, the virtual experience book control device 200 may detect at least one of body bending, a body rotation direction, a step, and a hand motion of the user. For example, the virtual experience book control device 200 may be equipped with a camera module to detect a body motion of the user by capturing the motion of the user. For another example, the virtual experience book control device 200 may include a support and a foothold for holding the body of the user to detect the body motion of the user.

If it is determined, in operation S630, that the body motion of the user is detected in operation S620, the virtual experience book control device 200 accordingly controls the represented image of the 3D virtual image content displayed on a screen in operation S640.

Here, the virtual experience book control device 200 may display the 3D virtual image content based on a first-person point of view or a third-person point of view according to selection manipulation of the user.

For example, in the case of the first-person point of view, when a running step of the user is detected while the 3D virtual image content is displayed on a screen, the virtual experience book control device 200 increases a scene switching rate of the represented image displayed on a screen according to a running speed of the user so that the user feels as if the user ran in a virtual space of the 3D virtual image content as a main character.

For another example, in the case of the first-person point of view, when a body rotation of the user is detected while the 3D virtual image content is displayed on a screen, the virtual experience book control device 200 may rotate a scene of the represented image displayed on a screen according to a rotation direction of the user. This operation may bring about an effect of switching a direction of a character (main character) or a gaze direction in the virtual space of the 3D virtual image content.

For another example, in the case of the third-person point of view, when a body rotation of the user is detected while the 3D virtual image content is displayed on a screen, the virtual experience book control device 200 may rotate a scene of the represented image displayed on a screen through the display unit 210 according to a rotation direction of the user. This operation may bring about an effect of switching a gaze direction of an observer viewing the virtual space of the 3D virtual image content regardless of a gaze of a character.

The screen switching of the represented image of the 3D virtual image content according to a body motion of the user may be performed in the same manner as that of 3D game programming.

Furthermore, in the case where a scene in which an event is stored is displayed on a screen while the 3D virtual image content is played in operation S650, the virtual experience book control device 200 notifies the existence of the event and provides guide information for guide the user to perform the event in operation S660.

Here, the event may be a mission, a quest, or a quiz, and may require selection manipulation of the user. In the case where event information is stored in a currently played image scene, the virtual experience book control device 200 may pop up or overlay screen information for requiring user selection or may display a flickering 3D object related to the event so as to notify the existence of the event to the user. When the event is selected and performed by selection manipulation of the user, the virtual experience book control device 200 may provide guide information for performing the event to the user.

When the performance of the event is completed or an event pass is selected by the user, the virtual experience book control device 200 may complete playback of a next image or playback of the 3D virtual image content.

As described above, according to an embodiment of the present invention, a 3D-game-based immersive virtual reality generation and experience device is provided beyond the concept of reading and viewing texts and pictures of analog books, so that a virtual experience book user (reader) may experience a book story through interaction such as walking or running in a virtual space of the book story, and may improve information understanding and learning ability through virtual experience performing various missions and events.

According to another embodiment of the present invention, the 3D virtual image is generated based on viewpoints of various characters in addition to a viewpoint of a writer, so that the user may enjoy a single book story from multiple viewpoints such as a first-person point of view and a third-person point of view.

Furthermore, the present invention may be used in the fields of information knowledge transfer, education, and entertainment according to the theme of a book story. If a traditional fairy tale or a history is provided in the form of a virtual experience book, intangible culture content may be generated into tangible content to be used as a tool for culture experience or education. Moreover, a physical exercise effect may also be obtained through control based on physical activity, and thus, the virtual book may also be used for physical strength improvement and exercise promotion.

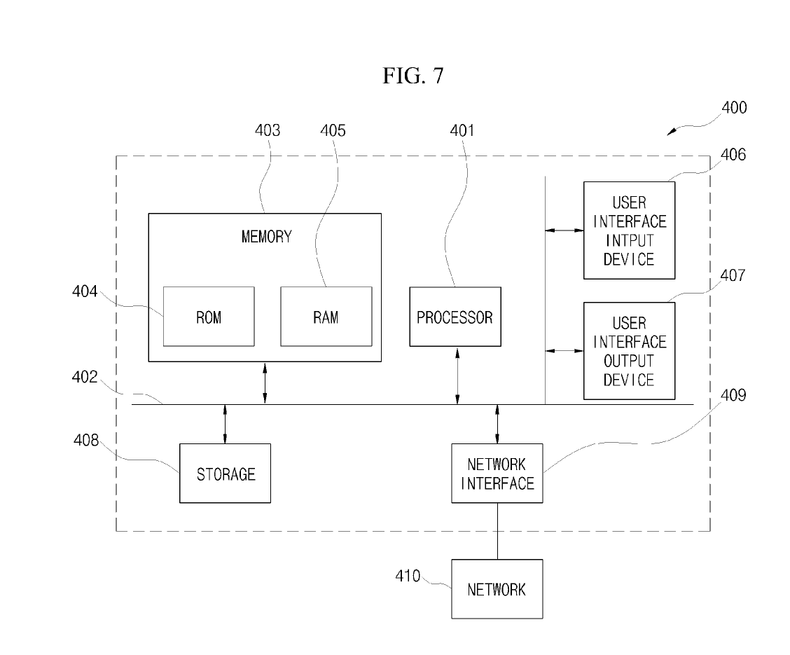

An embodiment of the present invention may be implemented in a computer system, e.g., as a computer readable medium. As shown in in FIG. 7, a computer system 400 may include one or more of a processor 401, a memory 403, a user input device 406, a user output device 407, and a storage 408, each of which communicates through a bus 402. The computer system 400 may also include a network interface 409 that is coupled to a network. The processor 401 may be a Central Processing Unit (CPU) or a semiconductor device that executes processing instructions stored in the memory 403 and/or the storage 408. The memory 403 and the storage 408 may include various forms of volatile or non-volatile storage media. For example, the memory may include a Read-Only Memory (ROM) 404 and a Random Access Memory (RAM) 405.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A virtual experience book system comprising:
a virtual experience book producing device configured to generate 3D virtual image content in consideration of a plurality of objects extracted from text information of a story; and
a virtual experience book control device configured to detect a body motion of a user while displaying the 3D virtual image content, and control a represented image of the 3D virtual image content so that a viewpoint is switched or arrangement locations of 3D models are changed according to the detected body motion.

2. The virtual experience book system of claim 1, wherein the virtual experience book producing device comprises:
an input unit configured to receive the text information of the story;
an analysis processing unit configured to extract the plurality of objects from the text information using a language analysis algorithm; and
an image generating unit configured to generate the 3D virtual image content using 3D computer graphics in consideration of the plurality of extracted objects.

3. The virtual experience book system of claim 1, wherein the virtual experience book control device comprises:
a display unit configured to display the represented image of the 3D virtual image content to provide the represented image of the 3D virtual image to the user;
a motion detection unit configured to detect the body motion of the user; and
a control unit configured to control the represented image of the 3D virtual image content according to a selection motion when the selection motion of the user is detected through the motion detection unit while the represented image of the 3D virtual image content is displayed through the display unit.

4. The virtual experience book system of claim 2, wherein the image generating unit obtains the 3D models respectively corresponding to the plurality of objects extracted from an extraction unit from a database so as to generate the 3D virtual image content.

5. The virtual experience book system of claim 4, wherein the image generating unit arranges the obtained 3D models according to a preset arrangement rule so as to generate the 3D virtual image content.

6. The virtual experience book system of claim 4, wherein, when the 3D model corresponding to the object does not exist in the database, the image generating unit obtains a 3D model that is most similar to the object from the database.

7. The virtual experience book system of claim 2, wherein the analysis processing unit extracts at least one of a background, a character, a noun, and a verb from the text information as the object.

8. The virtual experience book system of claim 2, wherein the image generating unit generates the 3D virtual image content based on at least one of a first-person point of view and a third-person point of view of the story.

9. The virtual experience book system of claim 3, wherein the motion detection unit detects at least one of body bending, a rotation direction, a step, and a hand motion of the user.

10. The virtual experience book system of claim 3, wherein the control unit switches a viewpoint of the 3D virtual image content so that the viewpoint becomes the first-person point of view or the third-person point of view according to manipulation or motion of the user.

11. The virtual experience book system of claim 3, wherein, when a selection motion of the user is detected through the motion detection unit while the represented image of the 3D virtual image content is displayed through the display unit, the control unit changes arrangement locations of the 3D models included in the 3D virtual image content according to the detected selection motion.

12. A method for producing a virtual experience book by a virtual experience book system, the method comprising:
receiving text information of a story;
extracting a plurality of objects from the text information using a language analysis algorithm; and
generating 3D virtual image content using 3D computer graphics in consideration of the plurality of extracted objects.

13. The method of claim 12, wherein the extracting comprises extracting at least one of a background, a character, a noun, and a verb from the text information as the object.

14. The method of claim 12, wherein the generating comprises:
obtaining 3D models respectively corresponding to the plurality of extracted objects from a database; and
arranging the obtained 3D models according to a preset arrangement rule so as to generate the 3D virtual image content.

15. The method of claim 14, wherein the obtaining comprises obtaining, when the 3D model corresponding to the object does not exist in the database, a 3D model that is most similar to the object from the database.

16. The method of claim 12, wherein the generating comprises generating the 3D virtual image content based on at least one of a first-person point of view and a third-person point of view of the story.

17. A method for controlling a virtual experience book by a virtual experience book system, the method comprising:
displaying a represented image of 3D virtual image to provide the represented image of the 3D virtual image to a user;
detecting a body motion of the user; and
controlling the represented image of the 3D virtual image content so that a viewpoint is switched or arrangement locations of the 3D models are changed according to a selection motion when the selection motion of the user is detected while the represented image of the 3D virtual image content is displayed through the display unit.

18. The method of claim 17, wherein the detecting comprises detecting at least one of body bending, a rotation direction, a step, and a hand motion of the user.

19. The method of claim 17, wherein the controlling comprises switching the viewpoint of the 3D virtual image content so that the viewpoint becomes a first-person point of view or a third-person point of view according to manipulation of the user.

20. The method of claim 17, wherein the controlling comprises:
checking whether the selection motion of the user is detected while the represented image of the 3D virtual image content is displayed; and
controlling, when the selection motion of the user is detected, the 3D models so that arrangement locations of the 3D models included in the 3D virtual image content are changed according to the detected selection motion.
